(19) United States
(12) Patent Application Publication
(10) Pub. No.: US 2023/0059597 A1
(43) Pub. Date: Feb. 23, 2023

(54) FUEL CELL FLOW FIELD DESIGNS DERIVED FROM ANISOTROPIC POROUS MEDIA OPTIMIZATION

(71) Applicant: Toyota Motor Engineering & Manufacturing North America, Inc., Plano, TX (US)

(72) Inventors: Yuqing Zhou, Ann Arbor, MI (US); Danny J. Lohan, Northville, MI (US); Tsuyoshi Nomura, Nagoya (JP); Ercan M. Dede, Ann Arbor, MI (US)

(73) Assignee: Toyota Motor Engineering & Manufacturing North America, Inc., Plano, TX (US)

(21) Appl. No.: 17/407,734

(22) Filed: Aug. 20, 2021

(51) Int. Cl. H01M 8/0263; H01M 8/023

(52) U.S. Cl. CPC H01M 8/0263; H01M 8/023

(57) ABSTRACT

A fuel cell that includes one or more fuel cell bipolar plates having a bipolar plate body with an inlet region, an outlet region, a reaction region arranged between and fluidically connected to the inlet region and the outlet region, and one or more microchannel fluid flow networks extending from the inlet region to the outlet region. The microchannel fluid flow networks include a plurality of primary flow microchannels having one or more secondary flow microchannels branching therefrom to facilitate reaction uniformity and fluid flow resistance through the fuel cell.

### TECHNICAL FIELD

Embodiments relate generally to one or more methods for designing fuel cell flow fields for optimized reaction-fluid performance.

### BACKGROUND

Microreactors (e.g., fuel cells) are widely used in energy storage and conversion systems whose flow fields play a significant role in their reaction-fluid performances.

A continuous-flow microreactor is an instrument that processes electro-chemical reactions with microchannel networking. It enables flow chemistry that cannot be done in batch. Microreactor technologies reveal a host of performance benefits enabled by the adoption of engineered microchannel fluid flow structures in biomedical, pharmaceutical and energy sectors.

Inside fuel cell stacks, starting reactants (i.e., air and hydrogen) are fed at the inlets by pumping and distributed via microchannel flow fields. The optimal design of flow fields plays a significant role in fuel cell performances.

Typical fuel cell flow fields are designed using forward design methods, where the flow path layout is fixed, and the size of pathways may be optimized to meet system requirements. This type of design method heavily depends on the initial layout, which is selected by the designer a priori. There are numerous examples of flow fields optimized using forward design to create pin, parallel, serpentine, interdigitated and mesh structures.

Researchers have also drawn inspiration from biology to design novel flow fields, including tree, lung, and fractal structures.

To facilitate out-of-the-box innovative designs, inverse design methods can be used, where the topology of the flow network is not defined a priori. The flow field design can be formulated as a material (i.e., fluid channel or wall) distribution problem. Optimization iterations are then used to arrive at a channel layout by minimizing target design objectives while performing physics simulations and sensitivity analysis. As an inverse design method, topology optimization has been applied to design microfluidic reactors, microbioreactors, hydrogen fuel cells, and redox flow batteries with significant reaction-fluid performance improvement when compared with conventional, forward designed reactors. Direct topology optimization methods where the material distribution at every discretized element (or node) is designed, however, require high computational cost and are often constrained to simple (i.e., limited channel number) academic problems.

In previous design methods, the isotropic permeability and infinite depth in the channel height dimension are assumed. The isotropic permeability assumption, however, can only be realized with highly discretized wall features (e.g., short Turing patterns).

### BRIEF SUMMARY

To address the aforementioned limitations, one or more embodiments set forth, described, and/or illustrated herein exploits an anisotropic porous media optimization and dehomogenization framework to design fuel cell flow fields. By abandoning the explicit modeling of channels during the optimization stage, which requires a large number of function evaluations, the physics inside anisotropic porous media can be captured with relatively coarse discretization of the design domain. The development of intricate space-filling microchannels in a refined domain discretization is performed only once to recover the optimized anisotropic porous media. As a result, the channel synthesis is scalable in a computationally efficient manner.

To design more continuous flow fields, which are favored by many fuel cell applications, the one or more embodiments provides for an anisotropic porous media design method with high contrast permeabilities along and which are perpendicular to the channel direction. To address the shallow depth nature in fuel cells and the effect of the diffusion layer, the one or more embodiments uses unit cell modeling to capture the three-dimensional (3D) out-of-plane effect. Through a diagonal inlet-outlet flow configuration example, both the reaction and fluidic performances are optimized simultaneously by applying a multi-objective algorithm. It is demonstrated that the optimized flow fields outperform (i.e., Pareto dominate) benchmark parallel and serpentine designs.

In accordance with one or more embodiments, fuel cell stacks comprise: one or more bipolar plates having a fuel cell bipolar plate body with an inlet region, an outlet region, a reaction region arranged between and fluidically connected to the inlet region and the outlet region, and one or more microchannel fluid flow networks extending from the inlet region to the outlet region. The microchannel fluid flow networks include a plurality of primary flow microchannels having one or more secondary flow microchannels branching therefrom to facilitate reaction uniformity and reduce fluid flow resistance through the fuel cell.

In accordance with one or more embodiments, fuel cell stacks comprise: one or more bipolar plates having a fuel cell bipolar plate body with an inlet region, an outlet region, a reaction region arranged between and fluidically connected to the inlet region and the outlet region, and one or more microchannel fluid flow networks extending from the inlet region to the outlet region. The microchannel fluid flow networks include a plurality of primary flow microchannels of varying channel length to direct fuel reactants towards the outlet region and one or more secondary flow microchannels of varying channel length branching from the primary flow microchannels in a dendritic manner to facilitate reaction uniformity and reduce fluid flow resistance through the fuel cell.

In accordance with one or more embodiments, a bipolar plate for fuel cells comprises: a bipolar plate body with an inlet region, an outlet region, a reaction region arranged between and fluidically connected to the inlet region and the outlet region, and one or more microchannel fluid flow networks extending from the inlet region to the outlet region. The microchannel fluid flow networks include a plurality of primary flow microchannels having one or more secondary flow microchannels branching therefrom to facilitate reaction uniformity and reduce fluid flow resistance through the fuel cell.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

The illustrated example embodiments are intended for purposes of illustration only, and not limited thereto. The various advantages of the embodiments of will become apparent to one skilled in the art by reading the following specification and appended claims, and by referencing the following drawings, in which:

FIG. 1 illustrates design and domain conditions of an example fuel cell bipolar plate, in accordance with one or more embodiments set forth, described, and/or illustrated herein.

FIGS. 2A to 2C illustrate a unit cell configuration of a microchannel fluid flow structure or network inside a fuel cell bipolar plate, unit cell analysis in a primary flow direction, and unit cell analysis in a secondary flow direction, in accordance with one or more embodiments set forth, described, and/or illustrated herein.

FIGS. 3A to 3F illustrate optimized anisotropic porous media results and the associated dehomogenized microchannel fluid flow structures or networks of a fuel cell bipolar plate design that prioritizes fluid flow performance, in accordance with one or more embodiments set forth, described, and/or illustrated herein.

FIGS. 4A to 4F illustrate optimized anisotropic porous media results and the associated dehomogenized microchannel fluid flow structures or networks of a fuel cell bipolar plate design that balances reaction performance and fluid flow performance, in accordance with one or more embodiments set forth, described, and/or illustrated herein.

FIGS. 5A to 5F illustrate optimized anisotropic porous media results and the associated dehomogenized microchannel fluid flow structures or networks of a fuel cell bipolar plate design that balances reaction performance and fluid flow performance, in accordance with one or more embodiments set forth, described, and/or illustrated herein.

FIGS. 6A to 6F illustrate optimized anisotropic porous media results and the associated dehomogenized microchannel fluid flow structures or networks of a fuel cell bipolar plate design that prioritizes reaction performance, in accordance with one or more embodiments set forth, described, and/or illustrated herein.

FIG. 7 illustrates a graph of a reaction-fluid performance of three optimized microchannel fluid flow structure or network designs and for a fuel cell bipolar plate, in accordance with one or more embodiments set forth, described, and/or illustrated herein, and two baseline conventional microchannel designs.

FIGS. 8A and 8B illustrates an example dehomogenized microchannel fluid flow structure or network of a fuel cell bipolar plate and a section of the primary flow microchannels and secondary flow microchannels of the dehomogenized microchannel fluid flow structure or network, in accordance with one or more embodiments shown and described herein.

### DETAILED DESCRIPTION

In accordance with one or more embodiments, an inverse design method used to design a fuel cell having an optimized microchannel design. In implementation of the design, initially, a spatially varying two-dimensional (2D) orientation field of the homogenized anisotropic porous media is optimized using an iterative, gradient-based algorithm. A time-dependent reaction-diffusion system is then applied to dehomogenize the optimized anisotropic porous media and synthesize 3D microchannel flow networks.

### Orientation Tensor Design Variable

The parameterization of the orientation field follows the orientation tensor method previously proposed for elastic composite design problems. In a prescribed design domain, the orientation at a point in 2D space is represented by an orientation tensor, a, which is related to an orientation vector, p=(p₁, p₂), as follows:

$$a = ( {a}_{i j} ) = ( \begin{matrix}{a}_{11} & {a}_{12} \\ sym . & {a}_{22}\end{matrix} ) = p ⊗ p = ( \begin{matrix}{p}_{1} {p}_{1} & {p}_{1} {p}_{2} \\ sym . & {p}_{2} {p}_{2}\end{matrix} ) \qquad ( 1 )$$

A 2×2 symmetric matrix field variable q=(qᵢⱼ)→(aᵢⱼ) with qᵢⱼ∈[0,1] is used as the design variable, which can be regularized with a Helmholtz PDE filter as follows:

−r²∇²\tilde{q}ᵢⱼ+\tilde{q}ᵢⱼ=\tilde{q}ᵢⱼ, (2)

where the filter radius r determines the overall smoothness of the designed orientation, and \tilde{q}ᵢⱼ is the regularized design variable.

The orientation tensor a can be written as follows:

$${a}_{ij} = f ( x ) = \{ \begin{matrix}N ( H ( {\tilde{q}}_{i j} ) ) , for i = j , \\ \sqrt{{a}_{i i} {a}_{jj}} ( 2 H ( {\tilde{q}}_{ij} ) - 1 ) , for i \neq j ,\end{matrix} \qquad ( 3 )$$

where H is a smoothed step function, which projects \tilde{q}ᵢⱼ to be bounded between 0 and 1. N is a transformation function for the hypercube-to-simplex projection (HSP) scheme, which transforms a box domain to a triangular domain in 2D. Let ξ=H(\tilde{q}₁₁) and η=H(\tilde{q}₂₂), the HSP scheme can be written as follows:

$$N ( ξ , n ) = \{ \begin{matrix}{a}_{11} = {\sum }_{i = 1}^{4} {x}_{i} {N}_{i} ( ξ , η ) , \\ {a}_{22} = {\sum }_{i = 1}^{4} {y}_{i} {N}_{i} ( ξ , η ) ,\end{matrix} \qquad ( 4 )$$

$$where$$

$$\{ \begin{matrix}{N}_{1} ( ξ , η ) = ( ξ - 1 ) ( η - 1 ) , \\ {N}_{2} ( ξ , η ) = - ξ ( η - 1 ) , \\ {N}_{3} ( ξ , η ) = - ξ η , \\ {N}_{4} ( ξ , η ) = - ( ξ - 1 ) η ,\end{matrix} and x = ( 0 , 1 , 0.5 , 0 ) , y = ( 0 , 0 , 0.5 , 1 ) . \qquad ( 5 )$$

Two tensor invariant conditions have to be satisfied in order to make an orientation tensor.

I₁=tr(a)=a₁₁+a₂₂=1, (6a)

I₂=det(a)=a₁₁a₂₂−a₁₂²=0. (6b)

After applying the HSP scheme, the inequality constraint a₁₁+a₂₂≤1 is always satisfied. An additional global integral constraint is introduced the enforce the first tensor invariant condition as follows:

∫_{D}(1−a₁₁−a₂₂)²dΩ−ϵ₁≤0, (7)

where ϵ₁ is an infinitesimal value.

In order to satisfy the second invariant condition, H(\tilde{q}₁₂) has to be either 0 or 1. To achieve this, another global integral constraint is introduced as follows:

∫_{D}4H(\tilde{q}₁₂)(1−H(\tilde{q}₁₂))dΩ−ϵ₂≤0, (8)

where ϵ₂ is also an infinitesimal value.

### Anisotropic Permeability Tensor

The global second-rank permeability tensor, K, of an anisotropic porous medium rotated by the orientation tensor, a, is interpolated as follows:

$$K = ( {K}_{ij} ) = ( \begin{matrix}{K}_{11} & {K}_{12} \\ sym . & {K}_{22}\end{matrix} ) , \qquad ( 9 )$$

$$where$$

$$\{ \begin{matrix}{K}_{11} = {a}_{11} ( {K}^{( 1 )} - {K}^{( 2 )} ) + {K}^{( 2 )} \\ {K}_{12} = {a}_{12} ( {K}^{( 1 )} - {K}^{( 2 )} ) \\ {K}_{21} = {K}_{12} \\ {K}_{22} = {a}_{22} ( {K}^{( 1 )} - {K}^{( 2 )} ) + {K}^{( 2 )}\end{matrix} \qquad ( 10 )$$

K⁽¹⁾ is the local permeability in the major flow direction along the microchannel, and K⁽²⁾ is the local permeability in the minor flow direction orthogonal to the microchannel. Both will be obtained via a local-level unit cell analysis, and Darcy's law is used to compute the effective porous medium permeability.

$${K}^{( n )} = \frac{{v}^{( n )} μ Δ {L}^{( n )}}{Δ {p}^{( n )}} , for n = 1 , 2 , \qquad ( 11 )$$

where v⁽ⁿ⁾ is the unit cell inlet velocity, μ is the fluid dynamic viscosity, L⁽ⁿ⁾ is the unit cell length, and Δp⁽ⁿ⁾ is the pressure drop.

### Multiphysics Equilibrium

The simplified governing physics inside FC stacks can be modeled with Navier-Stokes equations and advection-diffusion-reaction equations. The steady-state anisotropic fluid flow physics is assumed to be incompressible and laminar. Chemical reaction is assumed to be proportional to the reactant concentration.

The anisotropic fluid flow physics is governed by the Navier-Stokes equations as follows:

ρ(u·∇)u=−∇p+∇·(μ(∇u+(∇u)^{T}))−(μK⁻¹)u, (12a)

∇·u=0, (12b)

where ρ, μ, u, and p are the fluid density, dynamic viscosity, velocity vector (state variable) and pressure (state variable).

To model the reaction physics, the solved fluid velocity vector, u, is coupled with the advection-diffusion-reaction equations:

∇·(−D∇c)+u·∇c=R, (13a)

R=−βc, (13b)

where, c, is the concentration (state variable), R is the local reaction rate assumed proportional to the concentration, D is the diffusion coefficient, and β is the reaction rate.

### Optimization Formulation

To design efficient, high-performing, and reliable FC stacks, the identified objectives comprise overall reaction performance (i.e., enhanced reaction uniformity though the fuel cell) and fluid flow performance (i.e., reduced fluid flow resistance though the fuel cell). By enhancing the reaction uniformity across the design domain, the reaction area is utilized more efficiently, which often increases the total overall reaction through the fuel cell and enhances long-term system reliability. By reducing or otherwise minimizing the flow resistance, less pumping power is required, which enhances the system efficiency.

The reaction uniformity objective f₁ and the flow resistance objective f₂ are formulated as follows:

$${f}_{1} = {\int }_{D} {( \frac{c - {c}_{a v g}}{{c}_{a v g}} )}^{2} d Ω , \qquad ( 14 a )$$

$${f}_{2} = \frac{1}{2} {\int }_{D} ∇ u \cdot ( ∇ u + {( ∇ u )}^{T} ) d Ω . \qquad ( 14 b )$$

The multi-objective optimization of anisotropic porous media is formulated as follows:

$${minimize}_{{q}_{ij}} : F = {w}_{1} {f}_{1} + {w}_{2} {f}_{2} subject to : {q}_{i j} ∈ [ 0 , 1 ] , {g}_{1} := {\int }_{Ω} {( 1 - {a}_{11} - {a}_{22} )}^{2} d Ω - {ϵ}_{1} \leq 0 , {g}_{2} := {\int }_{Ω} 4 H ( {\tilde{q}}_{12} ) ( 1 - H ( {\tilde{q}}_{12} ) ) d Ω - {ϵ}_{2} \leq 0 , \\ design variable regularization and projection , Eqs . ( 1 - 5 ) , \\ multiphysics equilibrium , Eqs . ( 12 - 13 ) , \qquad ( 15 )$$

where w₁ and w₂ are weighting factors for the reaction uniformity and flow resistance design objectives. Different weighting factor settings can lead to various designs with trade-offs between the design objectives. ϵ₁ and ϵ₂ are infinitesimal values to ensure the two tensor invariant conditions, which can be gradually reduced in a continuation scheme during optimization.

### Microchannel Dehomogenization

A reaction-diffusion system is used to dehomogenize the optimized orientation field with microchannels. Its mathematical model involves two interacting hypothetical chemical substances whose concentrations are u and v. Their time-dependent local diffusion, reaction and replenishment can be described as follows:

$$\frac{\partial u}{\partial t} = ∇ \cdot ( {D}_{u} ∇ u ) + F ( u , v ) - {d}_{u} u ,$$

$$\frac{\partial u}{\partial t} = ∇ \cdot ( {D}_{v} ∇ v ) + G ( u , v ) - {d}_{v} v ,$$

$$where$$

$$0 \leq F ( u , v ) = {a}_{u} u + {b}_{u} v + {c}_{u} \leq {F}_{max} ,$$

$$0 \leq G ( u , v ) = {a}_{v} u + {b}_{v} v + {c}_{v} \leq {G}_{max} ,$$

Dᵤ and Dᵥ are diffusion tensors perturbed over time with a strong anisotropic state. The principal axis of the anisotropic diffusion tensor is aligned with the optimized orientation in anisotropic porous media. The diffusion tensors using the optimized orientation tensor ā can be written as follows:

Dᵤ(ā)=(wᵤw)²{lᵤ²ā+I}, (18a)

Dᵥ(ā)=(wᵥw)²{lᵥ²ā+I}, (18b)

where lᵤ and lᵥ control the magnitude of anisotropy and wᵤ and wᵥ control the pitch of the microchannels. By specifying the channel pitch, w=w_{c}+w_{w}, the lateral magnitude of the diffusion, is proportional to w². As a result, the prescribed unit cell geometry can be recovered.

### EXAMPLE

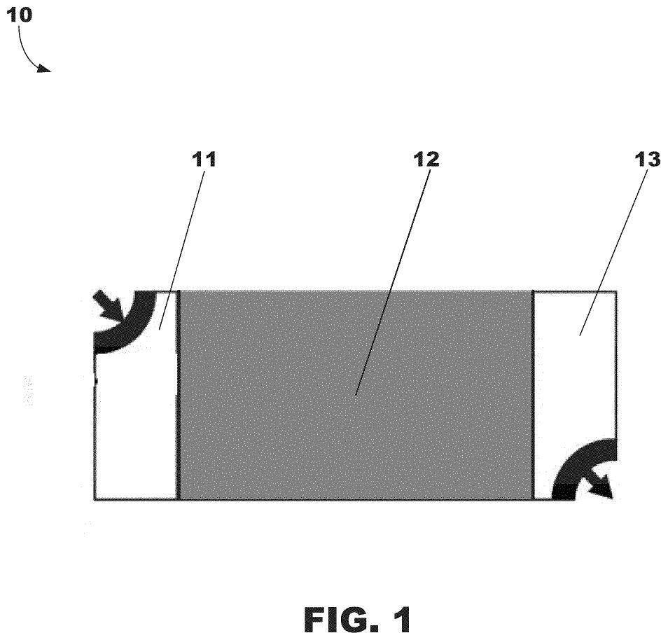

In the illustrated example of FIG. 1, a diagonal inlet-outlet fluid flow configuration is used to demonstrate an inverse design and dehomogenization framework as set forth, described, and/or illustrated herein. The bipolar plate 10 has an inlet region 11 located at an upper left corner thereof into which a fuel reactant is received by the FC, an outlet region 13 located at a bottom right corner thereof through which the fuel reactant leaves the FC, and a reaction region (shaded) 12 where the fuel reactants (e.g., hydrogen H₂ and air) mix. The multi-objective optimization problem in Eq. (15) is solved using the Method of Moving Asymptotes (MMA). COMSOL Multiphysics is used to solve for physics equilibrium and perform sensitivity analysis. COMSOL LiveLink for MATLAB is used to integrate COMSOL solutions into a MATLAB controlled iterative optimization loop. A continuation scheme to gradually reduce ϵ₁ and ϵ₂ is implemented to enforce tensor invariant conditions by the end of optimization routine. Tensor invariant conditions are relaxed in initial iterations to avoid early trap in the local minimum.

### Unit Cell Analysis

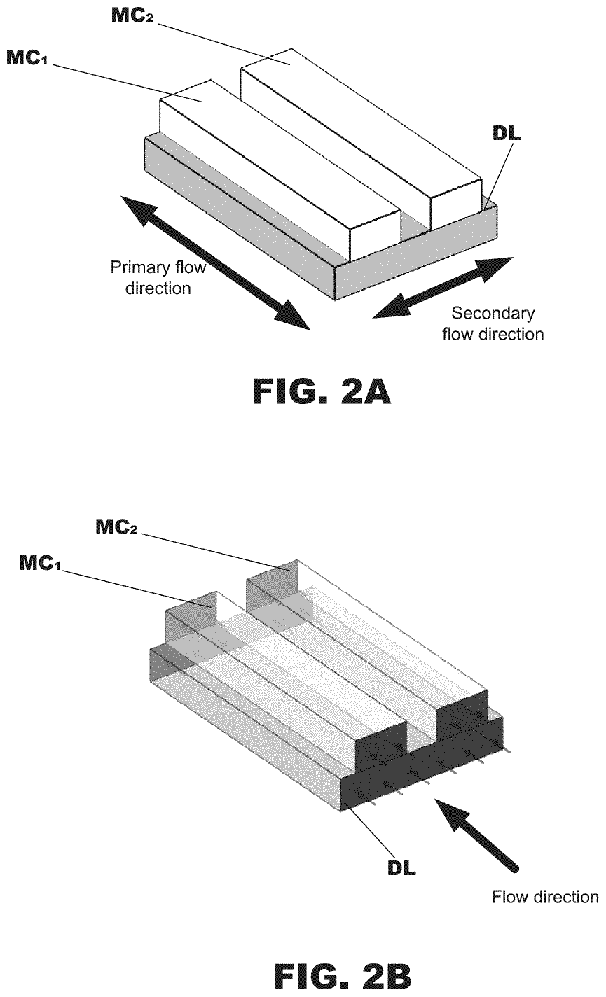

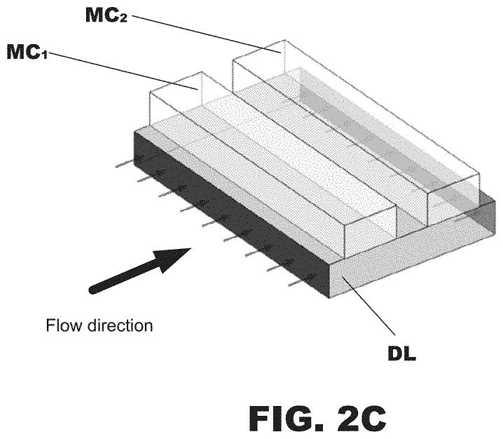

The effective anisotropic porous medium permeability given the geometric constraints is estimated using two separate local unit cell analyses. The geometry and boundary conditions for each example are presented in FIGS. 2A to 2C, in which in which a porous gas diffusion layer DL having a prescribed isotropic permeability has extending thereon a first microchannel MC₁ and a second microchannel MC₂.

Following Darcy's law (Eq. (11)), the effective permeability in the major flow direction along the microchannel, K⁽¹⁾, and the permeability in the minor or secondary flow direction orthogonal to the microchannel, K⁽²⁾, can be computed.

### Example Optimized Designs

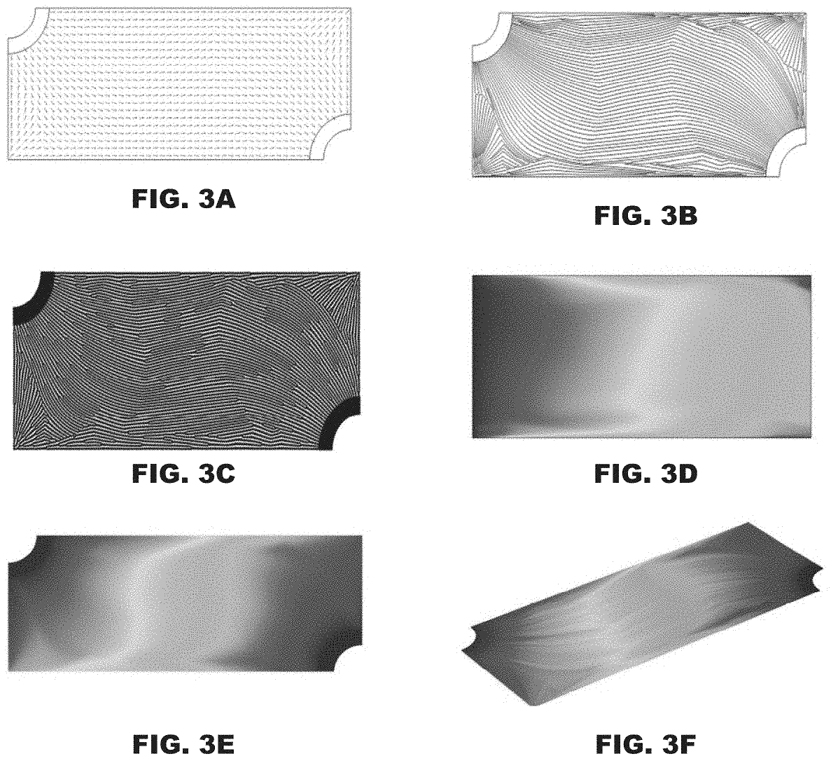

The COMSOL-Matlab interface was used to determine the tradeoff between the competing objectives by assigning different weighting factors in the multi-objective function. Four example optimized anisotropic porous media results and the corresponding dehomogenized microchannel flow networks are illustrated in FIGS. 3A to 3F, 4A to 4F, 5A to 5F, and 6A to 6F.

The illustrated example embodiments of FIGS. 3A, 4A, 5A, and 6A show the optimized flow orientation of the anisotropic porous media for each respective optimized microchannel design using orientation vectors.

The illustrated example embodiments of FIGS. 3B, 4B, 5B, and 6B show the optimized flow orientation of the anisotropic porous media for each respective optimized microchannel design using streamlines.

The illustrated example embodiments of FIGS. 3C, 4C, 5C, and 6C show the dehomogenized microchannel designs, which align well with the optimized orientation vectors, featuring natural branching, merging, and curving channels. The dark/black regions indicate the channel fluid domain and the light/white regions indicate the wall domain.

The illustrated example embodiments of FIGS. 3D, 4D, 5D, and 6D show the reaction performance, measured by reactant concentration, for each optimized fuel cell design using the porous media model set forth, described, and/or illustrated herein.

The illustrated example embodiments of FIGS. 3E, 4E, 5E, and 6E show the fluidic performance in 2D, measured by pressure, for each optimized microchannel design using the porous media model set forth, described, and/or illustrated herein.

The illustrated example embodiments of FIGS. 3F, 4F, 5F, and 6F show the fluidic performance in 3D, measured by pressure, for each optimized microchannel design using the porous media model set forth, described, and/or illustrated herein. To validate the 3D performance of the optimized microchannel designs, which were optimized using a 2D model, the optimized 2D fluid domain of the flow networks are extruded in the out-of-plane direction to create a 3D model. An additional diffusion layer is added underneath the extruded 3D microchannel fluid domain. The same mass flow rate is applied at the inlet and 0 Pa pressure is prescribed at the outlet for the 3D flow analyses. The simulated pressure profiles in 3D harmoniously correspond with those obtained using the 2D anisotropic porous media model. Not only do the pressure trends match well in 2D and 3D, but the total pressure drop between the 2D and 3D models are comparable for all four example optimized microchannel designs.

The illustrated example embodiment of FIGS. 3A to 3F present a “flow” optimized microchannel design 100 (FIG. 3C) that prioritizes flow performance. The “flow” optimized microchannel design 100 is obtained by assigning w₁=0.1 and w₂=0.9. Since the flow resistance objective is prioritized, the optimized flow field connects the inlet and outlet continuously and smoothly. Parallel microchannels result when recovering the optimized anisotropic porous media. While its pressure drop (FIGS. 3E and 3F) is the lowest among the four optimized microchannel designs, its reactant concentration (FIG. 3D) on the outlet side is relatively low, which may cause a reactant depletion issue. It bears noting that, because the microchannels in the lower left corner region and the upper right corner region of the plate are orientated orthogonally relative to the inlet and the outlet, the final commercial application of the fuel cell bipolar plate may be fabricated in a manner that removes (e.g., by cutting) these regions to obtain a final configuration.

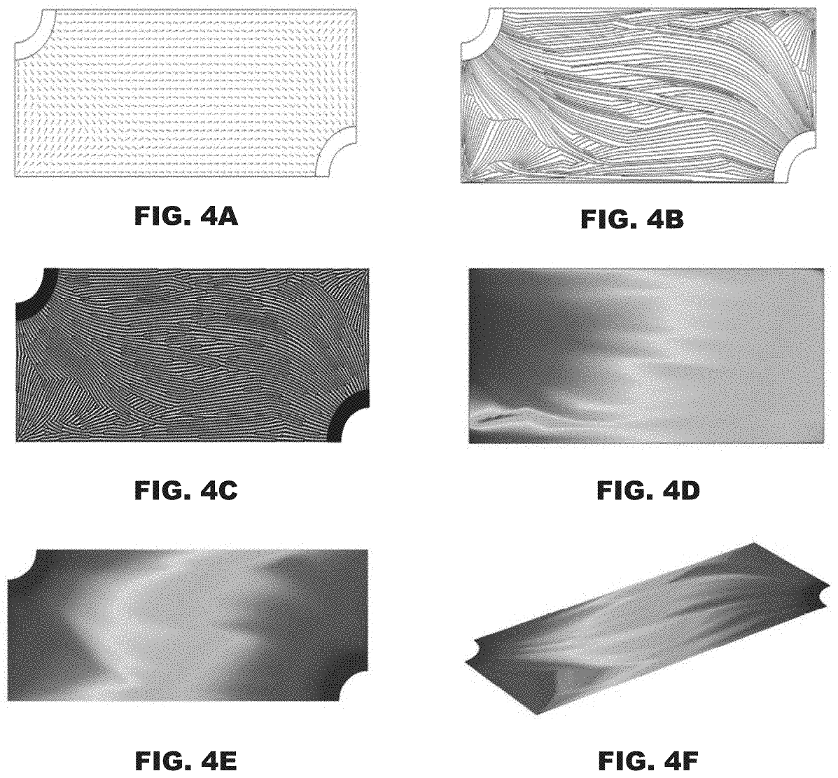

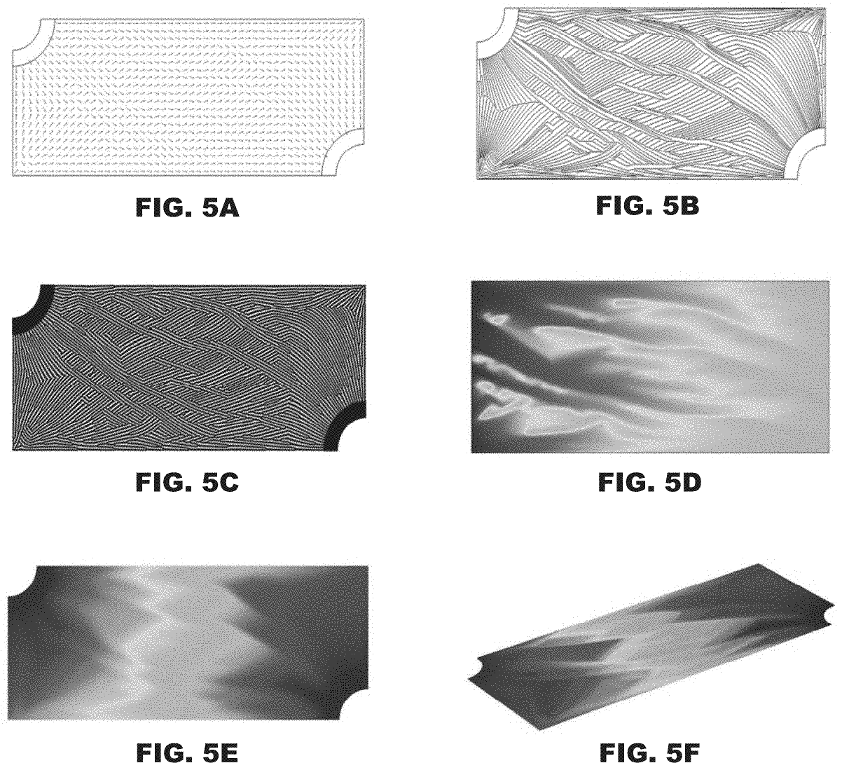

The illustrated example embodiment of FIGS. 4A to 4F and FIGS. 5A to 5F respectively present a “balanced” optimized microchannel design that balances uniform reaction and fluid flow resistance. The amount and degree of secondary branching depend on design preferences, which can be controlled by weighting factor settings in the multi-objective function. The primary flow microchannels dominate the design as the flow performance is prioritized while more secondary flow microchannels appear as better reaction performance is desired.

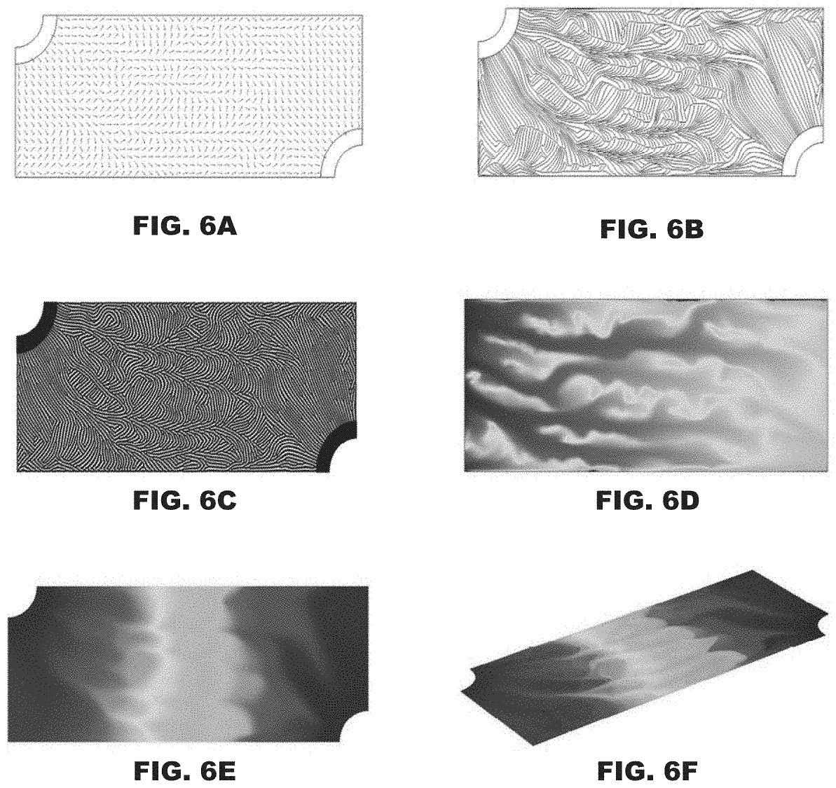

The illustrated example embodiment of FIGS. 6A to 6F present a “reaction” optimized microchannel design that prioritizes reaction performance. To achieve more uniform reaction across the plate, the “reaction” design is obtained by assigning w₁=0.9 and w₂=0.1 and a smaller filter radius r. The optimized microchannel design is a hierarchical structure comprising primary flow microchannel and secondary flow microchannels. Primary flow paths efficiently direct high concentration reactant towards the outlet side. The gaps between primary flow paths are filled with branching secondary flow paths to facilitate reactant distribution. The use of a smaller filter radius r effectively facilitates the formation of intricate branching secondary flow paths. It is noted that the “reaction” optimized microchannel design exhibits similar geometric patterns or configurations as those observed from naturally occurring systems (e.g., lungs, leaves, and blood vessels), which share a similar functionality of distributing reactants and evacuating waste products. While such bio-inspired flow fields have been investigated to design reactors in a forward design manner, embodiments set forth, described, and/or illustrated herein present large-scale hierarchical flow fields discovered using an inverse design approach without assuming prescribed layouts. As seen in the reactant concentration plot, the outlet side concentration of the “reaction” optimized microchannel design is greater than that of the “flow” optimized microchannel design. The more efficient use of reaction area not only enhances the reaction uniformity but increases the total reaction. This enhanced reaction performance comes at an increased pressure drop.

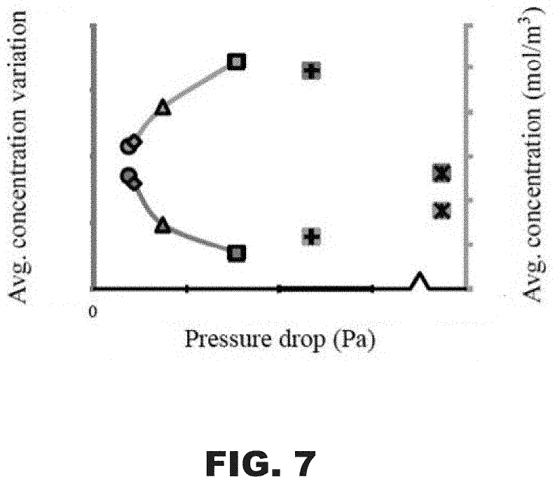

The illustrated example of FIG. 7 plots the reaction-fluid performance of the four example optimized microchannel designs and two baseline conventional channel designs (a parallel microchannel design and the serpentine microchannel design), where clear trade-offs between the reaction uniformity and fluid flow resistance are observed. The “O” symbol represents the “flow” optimized microchannel design (FIG. 3C) that prioritizes flow performance. The “ [symbol] ” and “Δ” symbols respectively represent the “balanced” optimized microchannel designs (FIGS. 4C and 5C) that balances uniform reaction and fluid flow resistance. The “ [symbol] ” symbol represents the a “reaction” optimized microchannel design (FIG. 6C) that prioritizes reaction performance. The “+” symbol represents the baseline parallel channel design and the “ [symbol] ” symbol represents the baseline serpentine channel design.

The reaction uniformity is measured by the average reactant concentration variation (left y-axis), the total reaction is measured by the average reactant concentration (right y-axis), and the flow resistance is measured by the total pressure drop (x-axis). The reaction-fluid performance of the example optimized microchannel designs outperforms the baseline parallel channel design and the baseline serpentine channel design.

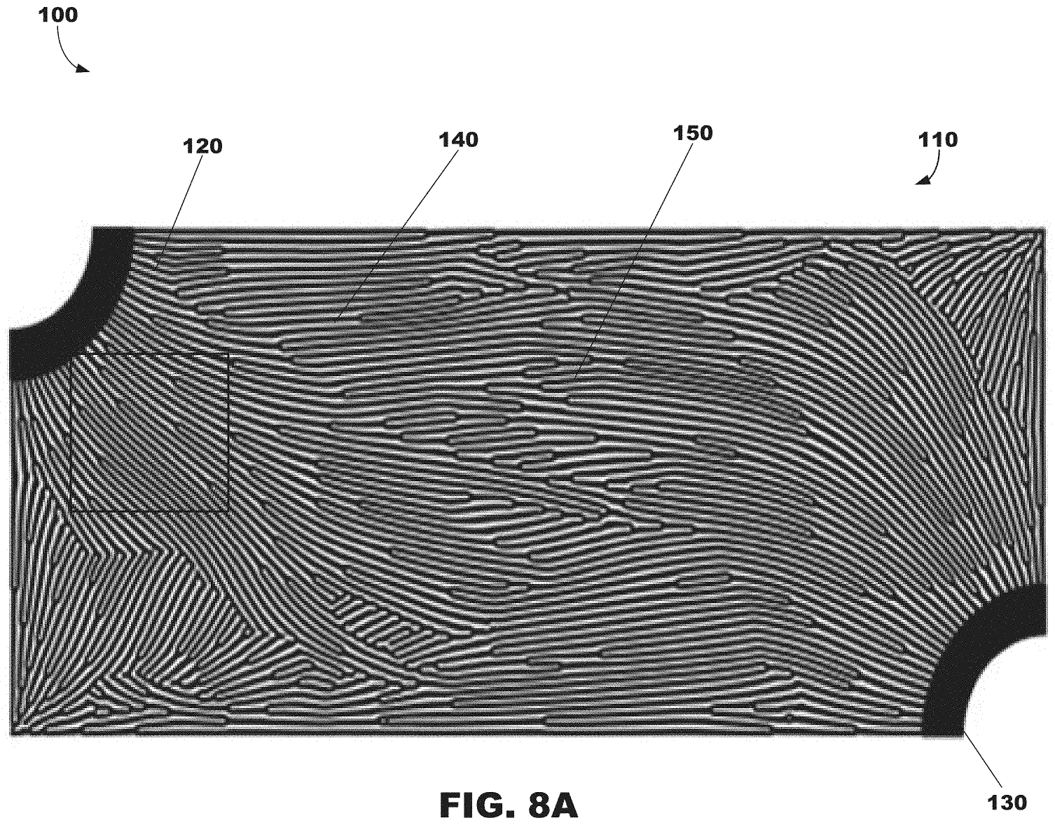

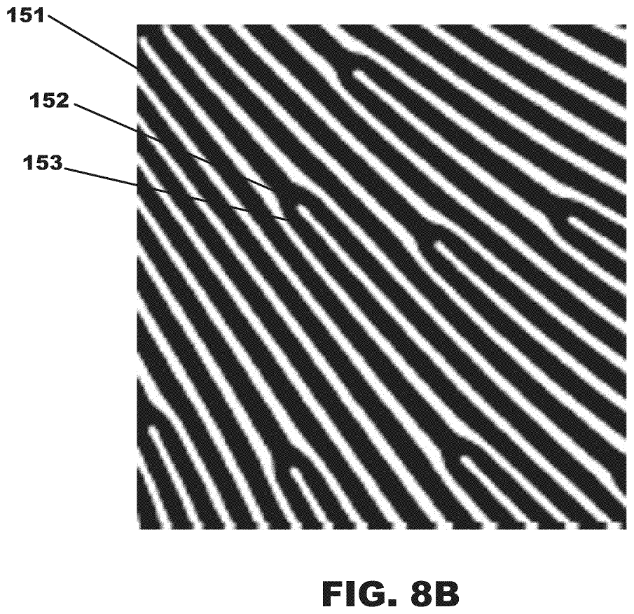

The illustrated example of FIG. 8A presents an example design of a fuel cell 100 that comprises a bipolar plate 110 including a body having one or more microchannel fluid flow networks 150 designed in accordance with the one or more methods set forth, described, and/or illustrated herein. The fuel cell bipolar plate 110 has an inlet region 120 through which a fluid having a fuel reactant (e.g., H₂) enters the fuel cell bipolar plate 110, a reaction region 150 where the reactants (e.g., hydrogen H₂ and air) mix, and an outlet region 130 through which the fluid leaves the fuel cell 100.

As illustrated in FIG. 8B, the microchannel fluid flow networks 150, configured to extend from the inlet region 120 to the outlet region 130, comprise a plurality of large, primary flow microchannels 151 of varying channel length having one or more small, secondary flow microchannels 152 of varying channel length branching off the primary flow microchannels 141. As used herein, the term “larger” is to mean a channel having a channel width and/or length that is greater than that of another channel. As also used herein, the term “smaller” is to mean a microchannel having a channel width and/or channel length that is less than that of another channel.

In one or more embodiments, the secondary flow microchannels 152 branch off from the primary flow microchannels 151 in a dendritic manner, thus forming a microchannel fluid flow network 150 having a biomimetic microstructure configuration that may be selectively designed to satisfy different aspects of design requirements and performance objectives of the fuel cell. Although the == of the illustrated example is designed to facilitate minimized fluid flow resistance, embodiments are not limited thereto. For example, the overall number and channel length of the primary flow microchannels 151 and secondary flow microchannels 152 may be selectively adjusted in the design phase in a manner which collectively form a geometric pattern or configuration that prioritizes: reaction uniformity of the fuel cell (FIG. 6C), or fluid flow resistance of the fuel cell (FIG. 3C), or a balance between reaction uniformity and fluid flow resistance of the fuel cell (FIGS. 4C and 5C).

In accordance with one or more embodiments, an inverse design and dehomogenization framework for designing fuel cell flow fields having the optimized reaction-fluid performance. The weighted multi-objective optimization was solved by applying a gradient-based algorithm. To design spatially varying orientations, orientation tensor elements are parameterized and used as design variables. Local tensor invariant conditions are formulated as global integral constraints. To translate the optimized channel flow orientations into intricate microchannel designs, a reaction-diffusion system is used to dehomogenize the anisotropic porous media and obtain a plurality of optimized microchannel designs. Clear trade-offs between reaction performance and fluidic performance are observed, and hierarchical flow fields, comprising a plurality of primary flow microchannels and secondary flow microchannels, similar to biomimetic or nature systems (e.g., lungs, leaves and blood vessels) are generated using an inverse design framework. The amount and degree of secondary branching of flow fields may be controlled by weighting factor settings in the multi-objective optimization algorithm. Conventional parallel and serpentine flow field designs were outperformed by the inversely designed optimized flow fields (i.e., Pareto domination).

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the one or more embodiments can be implemented in a variety of forms. Therefore, while the embodiments are set forth, illustrated, and/or described in connection with particular examples thereof, the true scope of the embodiments should not be so limited since other modifications will become apparent to the skilled practitioner upon a study of the drawings, specification, and claims.

What is claimed is:

1. A fuel cell, comprising:
one or more fuel cell bipolar plates having a bipolar plate body with an inlet region, an outlet region, a reaction region arranged between and fluidically connected to the inlet region and the outlet region, and one or more microchannel fluid flow networks at the reaction region, the microchannel fluid flow networks including a plurality of primary flow microchannels having one or more secondary flow microchannels branching therefrom to facilitate reaction uniformity and fluid flow resistance through the fuel cell.

2. The fuel cell of claim 1, wherein the one or more microchannel fluid flow networks have a microstructural configuration that facilitates enhanced reaction uniformity.

3. The fuel cell of claim 2, wherein the one or more microchannel fluid flow networks comprise:
continuous primary flow microchannels and secondary flow microchannels, extending from the inlet region, having substantially parallel flow orientations directed towards the outlet region;
discrete primary flow microchannels and secondary flow microchannels at the reaction region having flow orientations directed orthogonal to the outlet region; and
continuous primary flow microchannels and secondary flow microchannels, extending into the outlet region, having substantially parallel flow orientations directed towards the outlet region.

4. The fuel cell of claim 1, wherein the one or more microchannel fluid flow networks have a geometric microstructural configuration that facilitates minimized fluid flow resistance.

5. The fuel cell of claim 4, wherein the one or more microchannel fluid flow networks comprise:
continuous primary flow microchannels and secondary flow microchannels at the inlet region having substantially parallel flow orientations directed towards the outlet region;
continuous primary flow microchannels and secondary flow microchannels at the reaction region having substantially parallel flow orientations directed towards the outlet region; and
continuous primary flow microchannels and secondary flow microchannels, extending into the outlet region, having substantially parallel flow orientations directed towards the outlet region.

6. The fuel cell of claim 1, wherein the one or more microchannel fluid flow networks have a geometric microstructural configuration that facilitates a balance between reaction uniformity and minimized flow resistance of the fuel cell.

7. The fuel cell of claim 6, wherein the one or more microchannel fluid flow networks comprise:
continuous primary flow microchannels and secondary flow microchannels, extending from the inlet region, having substantially parallel flow orientations directed towards the outlet region;
discrete primary flow microchannels and secondary flow microchannels at the reaction region having flow orientations directed orthogonal to the outlet region, and continuous primary flow microchannels and secondary flow microchannels at the reaction region having substantially parallel flow orientations directed towards the outlet region; and
continuous primary flow microchannels and secondary flow microchannels, extending into the outlet region having substantially parallel flow orientations directed towards the outlet region.

8. A fuel cell, comprising:
one or more fuel cell bipolar plates having a bipolar plate body with an inlet region, an outlet region, a reaction region arranged between and fluidically connected to the inlet region and the outlet region, and one or more microchannel fluid flow networks extending from the inlet region to the outlet region, the microchannel fluid flow networks including a plurality of primary flow microchannels of varying channel length to direct fuel reactants towards the outlet region and one or more secondary flow microchannels of varying channel length branching from the primary flow microchannels in a dendritic manner to facilitate reaction uniformity and fluid flow resistance through the fuel cell.

9. The fuel cell of claim 8, wherein the one or more microchannel fluid flow networks have a microstructural configuration that facilitates enhanced reaction uniformity.

10. The fuel cell of claim 9, wherein the one or more microchannel fluid flow networks comprise:
continuous primary flow microchannels and secondary flow microchannels, extending from the inlet region, having substantially parallel flow orientations directed towards the outlet region;
discrete primary flow microchannels and secondary flow microchannels at the reaction region having flow orientations directed orthogonal to the outlet region; and
continuous primary flow microchannels and secondary flow microchannels, extending into the outlet region, having substantially parallel flow orientations directed towards the outlet region.

11. The fuel cell of claim 8, wherein the one or more microchannel fluid flow networks have a geometric microstructural configuration that facilitates minimized fluid flow resistance.

12. The fuel cell of claim 11, wherein the one or more microchannel fluid flow networks comprise:
continuous primary flow microchannels and secondary flow microchannels, extending from the inlet region, having substantially parallel flow orientations directed towards the outlet region;
continuous primary flow microchannels and secondary flow microchannels at the reaction region having substantially parallel flow orientations directed towards the outlet region; and
continuous primary flow microchannels and secondary flow microchannels, extending into the outlet region, having substantially parallel flow orientations directed towards the outlet region.

13. The fuel cell of claim 8, wherein the one or more microchannel fluid flow networks have a geometric microstructural configuration that facilitates a balance between reaction uniformity and minimized flow resistance of the fuel cell.

14. The fuel cell of claim 13, wherein the one or more microchannel fluid flow networks comprise:
continuous primary flow microchannels and secondary flow microchannels, extending from the inlet region, having substantially parallel flow orientations directed towards the outlet region;
discrete primary flow microchannels and secondary flow microchannels at the reaction region having flow orientations directed orthogonal to the outlet region, and continuous primary flow microchannels and secondary flow microchannels at the reaction region having substantially parallel flow orientations directed towards the outlet region; and
continuous primary flow microchannels and secondary flow microchannels, extending into the outlet region, having substantially parallel flow orientations directed towards the outlet region.

15. A bipolar plate for a fuel cell, the bipolar plate comprising:
a bipolar plate body with an inlet region, an outlet region, a reaction region arranged between and fluidically connected to the inlet region and the outlet region, and one or more microchannel fluid flow networks extending from the inlet region to the outlet region, the microchannel fluid flow networks including a plurality of primary flow microchannels having one or more secondary flow microchannels branching therefrom to facilitate reaction uniformity and fluid flow resistance through the fuel cell.

16. The bipolar plate of claim 15, wherein the one or more microchannel fluid flow networks have a microstructural configuration that facilitates enhanced reaction uniformity.

17. The bipolar plate of claim 16, wherein the one or more microchannel fluid flow networks comprise:
continuous primary flow microchannels and secondary flow microchannels, extending from the inlet region, having substantially parallel flow orientations directed towards the outlet region;
discrete primary flow microchannels and secondary flow microchannels at the reaction region having flow orientations directed orthogonal to the outlet region; and
continuous primary flow microchannels and secondary flow microchannels, extending into the outlet region having substantially parallel flow orientations directed towards the outlet region.

18. The bipolar plate of claim 15, wherein the one or more microchannel fluid flow networks have a geometric microstructural configuration that facilitates minimized fluid flow resistance.

19. The bipolar plate of claim 18, wherein the one or more microchannel fluid flow networks comprise:
continuous primary flow microchannels and secondary flow microchannels, extending from the inlet region, having substantially parallel flow orientations directed towards the outlet region;
continuous primary flow microchannels and secondary flow microchannels at the reaction region having substantially parallel flow orientations directed towards the outlet region; and
continuous primary flow microchannels and secondary flow microchannels, extending into the outlet region, having substantially parallel flow orientations directed towards the outlet region.

20. The bipolar plate of claim 15, wherein the one or more microchannel fluid flow networks have a geometric microstructural configuration that facilitates a balance between reaction uniformity and minimized flow resistance of the fuel cell.

21. The bipolar plate of claim 20, wherein the one or more microchannel fluid flow networks comprise:
continuous primary flow microchannels and secondary flow microchannels, extending from the inlet region, having substantially parallel flow orientations directed towards the outlet region;
discrete primary flow microchannels and secondary flow microchannels at the reaction region having flow orientations directed orthogonal to the outlet region, and continuous primary flow microchannels and secondary flow microchannels at the reaction region having substantially parallel flow orientations directed towards the outlet region; and
continuous primary flow microchannels and secondary flow microchannels, extending into the outlet region, having substantially parallel flow orientations directed towards the outlet region.
